(19) United States
(12) Patent Application Publication
(10) Pub. No.: US 2004/0079816 A1
(43) Pub. Date: Apr. 29, 2004

(54) Easy sprayer: a sprayer assembly in which a foot operated pump is used to pressurize the sprayers' tank

(76) Inventor: Ester Lee Daniel JR., Clinton, LA (US)

Correspondence Address: Ester Lee Daniel Jr., 11532 Bank Street, P.O. Box 630, Clinton, LA, 70722-0000, US

(21) Appl. No.: 10/282,961

(22) Filed: Oct. 28, 2002

(51) Int. Cl. B05B 15/06; A01G 25/06

(52) U.S. Cl. 239/200

(57) ABSTRACT

In this design of a garden sprayer, a foot pump and the tank of a sprayer are connected to a common base. The tank is pressurized by stepping repeatedly on the foot-operated air pump, pushing air through the airline of the foot pump, then through an air inlet in the upper section of the tank. The built up air pressure in the tank pushes the liquid in the tank out through the sprayer hose, then through the sprayer nozzle when the nozzle valve is opened.

The Easy Sprayer is a manually operated sprayer assembly such as those used to spray herbicides, pesticides, industrial compounds, etc. As the name implies the Easy Sprayer was designed to make the physical operation of the common sprayer easier. It has two basic features that make it different from other manually operated sprayers. These features are a foot-operated air pump with witch to pressurize the sprayer tank and a base (a platform) on witch both the foot operated pump and the tank of the sprayer are attached.

This concept in the design and operation of the sprayer can take many forms, and many different types and designs of foot-operated pumps can be used in the construction of an Easy Sprayer. Models of the easy sprayer can be equipped with an attachable or a completely integrated doily to aid in the transport of the assembly. The ease of operation of the Easy sprayer's format of foot-operated pump and sprayer tank especially when also equipped with a doily will make it the most popular manually pressurized sprayer assembly to hit the market.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABGLE OR COMPUTER PROGRAM LISTING COMPACT APPANDIX

Not Applicable

### BACK GROUND OF THE INVENTION

### The Easy Sprayer

An idea for a new sprayer format had been on a shelf in my mind for years, I had no intension of removing it from this mental shelf until one day, while pumping the air pump of a garden sprayer to regain a good useable pressure in the tank the handle came out! This was the last straw in a series of problems I had with my garden sprayer that day. So I went to my old Chevy truck to remove an old foot pump, a flat board, and a peace of brake line, items I had gathered together long ago to serve the purpose they were now about to. These parts with the help of an automotive bonder, I used to assemble the ideal that had fallen from my mental shelf On that day The Easy Sprayer was born.

The Easy Sprayer is an assembly of subject matter brought together to form a new format for the common sprayer, garden sprayers, industrial sprayers, all sprayers that use the same basic format of a hand operated pump to pressurize the tank that holds a liquid that is to be showered over an area. It is related to the prior art of pressurized sprayers. It is designed to be an alternative to the utility designs of the prior art. The prior art includes sprayer designs that use electric motors; gravidity feed designs, hand pump designs, dual tank designs, water hose attachment designs, improvements such as pressure release valves, nozzle holders, Toy type designs, and other types of related designs. The Easy Spray was designed to be another alternative to the manually operated sprayer designs that incorporate a built in hand operated air pump. It like the powered, water hose attachment types, and gravidity feed designs; was designed to make the spraying of herbicides, fertilizers, pesticides, industrial liquids, and other fluids easier. I believe that sprayer designs witch incorporate pumps designed to be operated by use of the human foot repeatedly stepping on then off the pumps leaver or plunger, etc. will become the standard in the field of manually pressurized sprayers.

### DESCRIPTION OF THE PRIOR ART

There are many different models of the sprayer, from the manually operated to the powered. Here is a list of some of the prior art. U.S. Pat. Nos. 4,801,088: 4,925,105: 5,154,317: 5,152,462: D334,615: 5,775,595; 6,135,361; 5,921,455; 6,129,854; 6,109,548. Sprayers that are manually pressurized by pulling up and pushing down repeatedly the hand operated air pumps built into the tops that seal the tanks, are the designs of the prior art that the easy sprayer was basically designed to compete with. The drawback in the hand air pump designs is that the operators of the sprayers most stop spraying in order to pressurize the sprayer tanks. And as the fluid levels in the tanks drop it takes more and more effort to pressurize the tanks.

Most of the sprayer tank designs of the prior art can very easily be converted for use in the composition of subject matter called The Easy Sprayer assembly. For that reason I the Inventor of The Easy Sprayer composition; claim that the use of any pump designed to be operated by the user's using one (or both) of his or her two feet to repeatedly step down on then off of it (it being the pump) in order to pressurize a sprayer tank to be my invention. None of the prior art presents a format that prevents the introduction of this sprayer and foot-operated pump composition.

### BRIEF SUMMARY OF THE INVENTION

The Easy Sprayer is a composition of subject matter brought together to make the physical use of the manually pressurized sprayer easier. Its core design witch incorporates a foot operated air pump and a base (a platform) on witch both foot pump and sprayer tank are attached, allow the user to use the much stronger muscles of the legs, in stead of the upper body muscles of the chest and arms to pump the air pump witch pressurizes the sprayer tank. A great advantage of this design over the prior art of models of sprayers that use the built in hand pump design, is that the user of the easy sprayer dose not have to, bend over to operate the air pump witch pressurizes the tank Its features allow the user to use the sprayer in two different ways. It can be pressurized carried and used until the pressure drops then pressurized again, or it can be placed on the ground and the contents of the tank continually sprayed, while the user maintains a useable air pressure in the tank at all times by steady pumping the foot operated air pump. The second method of operation makes it possible for the user to spray the contents from the sprayer tank almost non stop, not even stopping when moving the sprayer assembly a short distance.

The incorporation of a doily into this composition of subject matter called the Easy Sprayer furthers the utility of the composition. Now a greater ease in transporting an assembly is added to the ease the foot-pump brings to pressurizing the sprayer tank in the assembly. The operators of the assemblies can also use the doilies to balance themselves when pumping the foot-operated pumps of the assemblies.

### BRIEF DESCRIPTION OF THE SEVERAL VIEWS OF THE DRAWINGS

The drawings along with the detailed description will quickly show that witch is new in the utility design of the Easy Sprayer, when compared with the prior art.

FIG. 1 is the solid cap and handle of the new format of garden sprayer.

FIG. 2 is the air inlet added to the sprayer tank to connect the external air supply.

FIG. 3 is an airline that connects the foot pump to the sprayer tank.

FIG. 4 is the base on witch the foot pump and the sprayer tank are connected

FIG. 5 is the foot pump used to pressurize the sprayer tank.

FIG. 6 is the sprayer hose.

FIG. 7 is the sprayer tank.

FIG. 8 is a drawing of a completed assembly of an Easy Sprayer as originally conceived

FIG. 9 in this view the subject matter that is new in the utility design of the sprayer (garden sprayers, industrial sprayers, etc.) is pointed out. These parts are a base, FIG. 4; a foot pump FIG. 5, an air in let for the external air supply FIG. 3, and a solid cap with handle FIG. 1

FIGS. 10 through 15 show six different means of connecting the foot pump and the garden sprayer tank to the common base.

FIG. 16 is an illustration of the subject matter of the Easy Sprayer designed as components of a conversion kit that can be used to transform different brands and models of garden sprayers into a version of an easer sprayer.

FIG. (17) and FIG. (23) are each example of a universal tank holder, a mechanism designed to hold garden sprayer tanks of different diameters.

FIG. (21) is an example of an air inlet adaptor designed for the sprayer hose connections of different models of garden sprayers.

FIG. (20) is an example of an adaptor with an air inlet for the airline of a foot operated air pump, designed to be installed at the locations of accessories such as the pressure release valves of different brands and models of garden sprayers.

FIG. (18) is an example of a top with an air inlet for the airline of a foot-operated air pump designed to replace the hand pumps of different models of garden sprayers.

FIG. (19) is an illustration of a section of hose and hard ware to extend the length of the sprayer hose of different models of garden sprayers.

FIGS. (22, 24, 25, 26 and 27) are illustrations of the easy sprayer base designed as a doily on witch the remaining components of foot-pump and sprayer tank are then solidly attached.

FIGS. (28, 29, 30, 3l and 32) show the easy sprayer as a system of doily and easy sprayer base assembly, in witch the doily is designed to transport the assembly, and if needed the assembly can be easily be picked up and removed from the doily, to be used independently of the doily, and easily be reinstalled onto the doily by placing the assembly back into the doily' tray.

FIG. 33 is an illustration of a possible factory model of an Easy Sprayer with doily assembly. This design is based on the standardization of the sprayer tanks that are to be used with it. It is designed to hold securely tanks of different capacities but designed with the same circumference. For example tanks of two, three, four, five, or six gallons can be manufactured each to fit securely with little effort held within a circular tray at the base, and the side railing of the doily, and secured with a sturdy belt, strap, chain, or band.

### DETAILED DESCRIPTION OF THE INVENTION

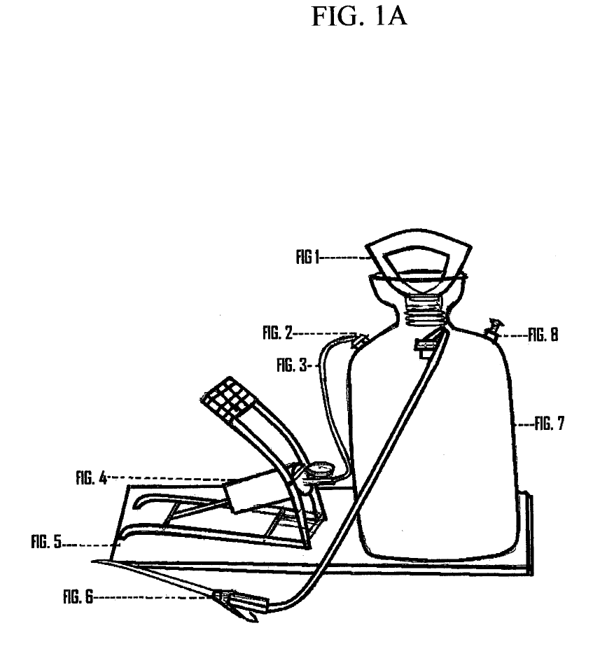

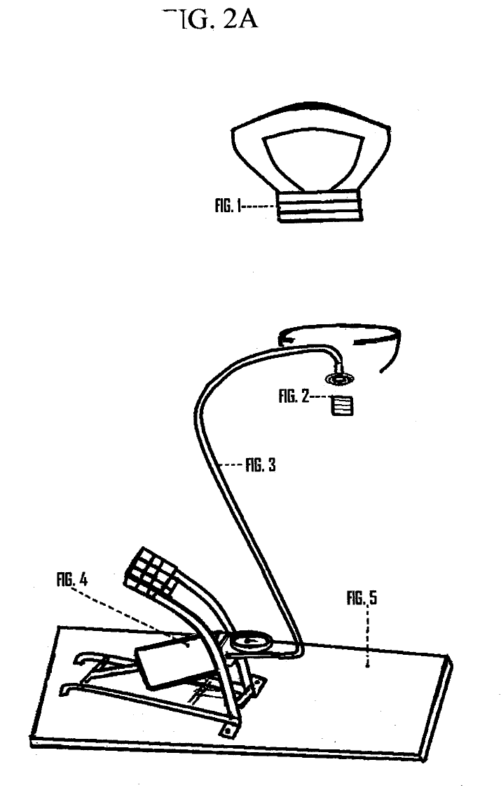

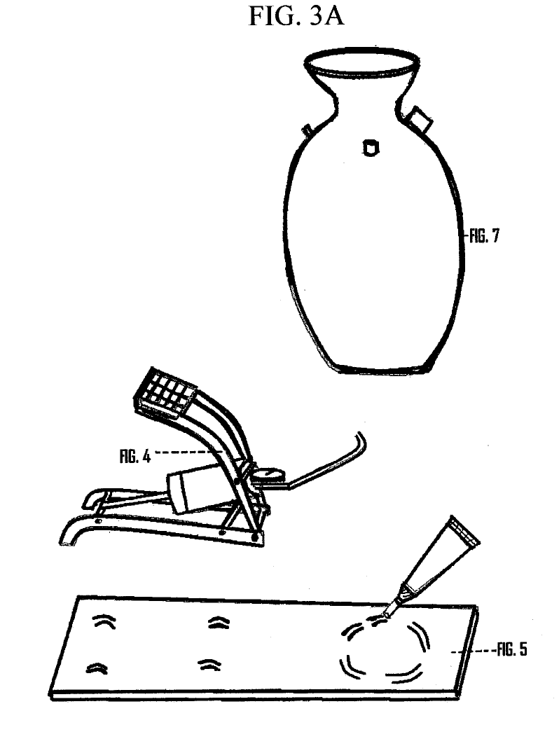

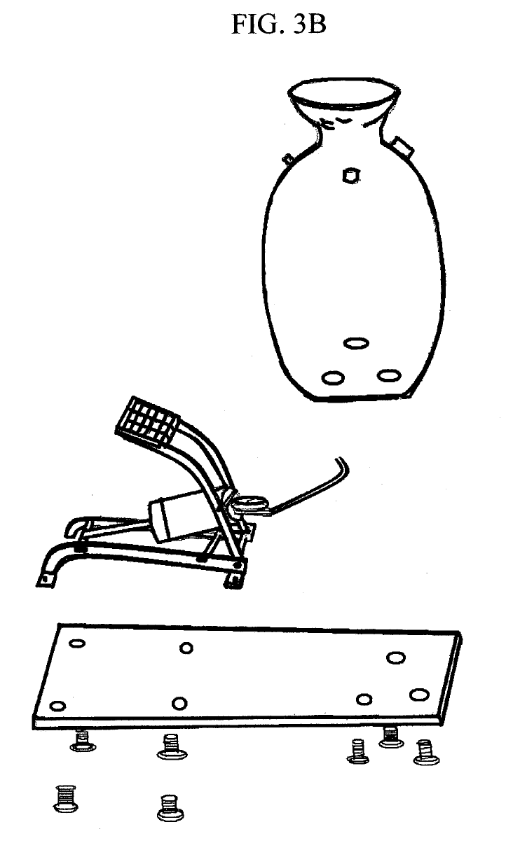

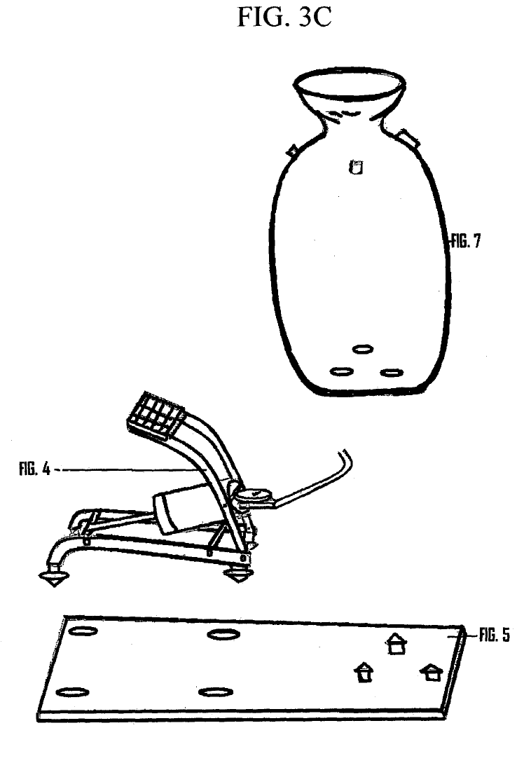

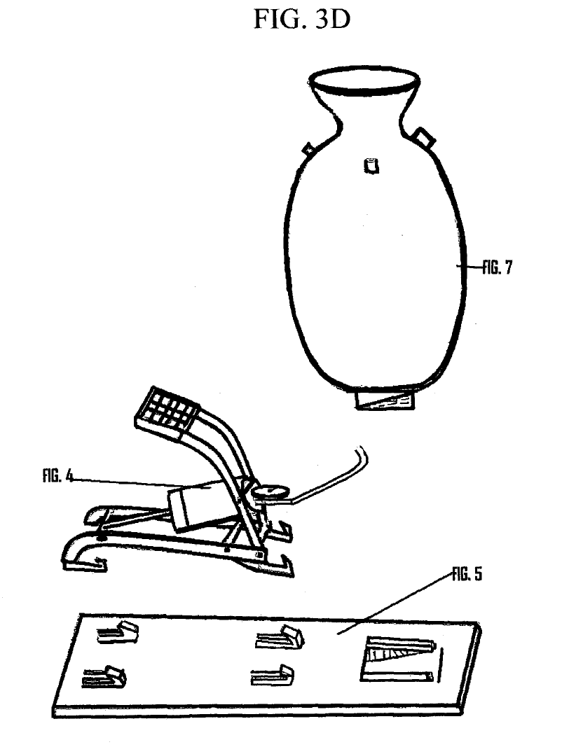

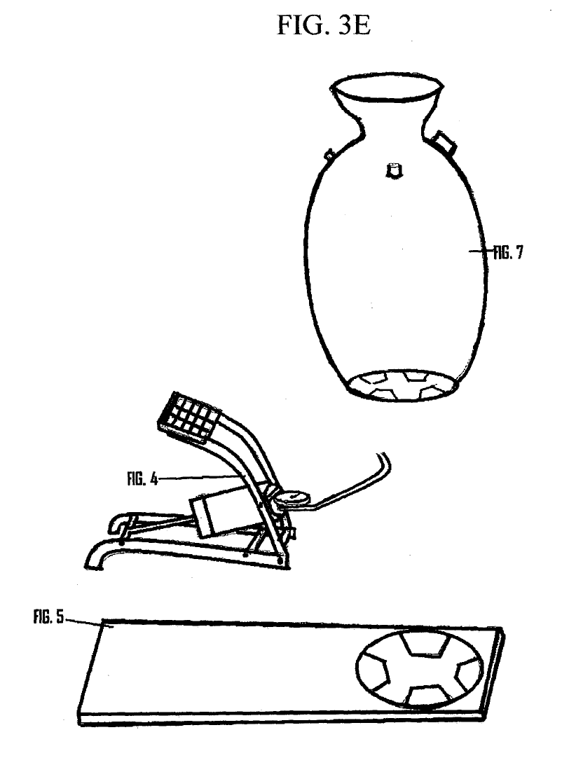

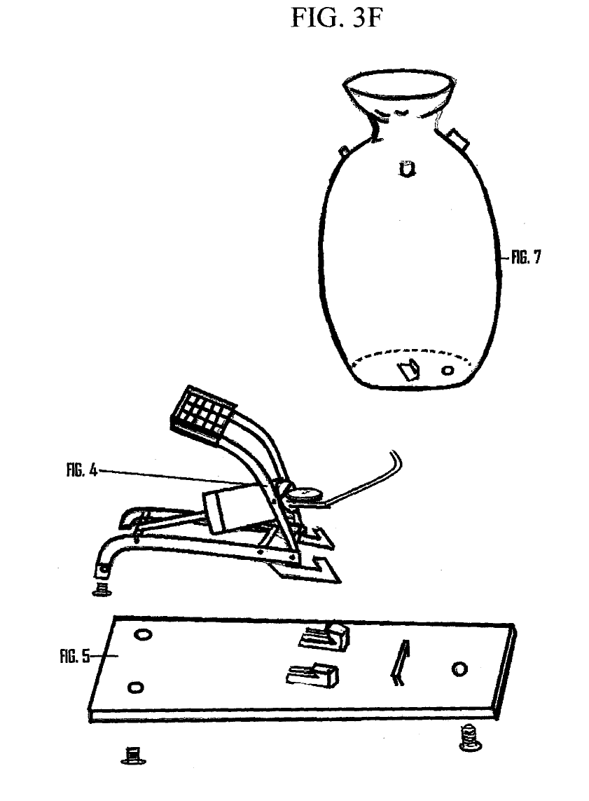

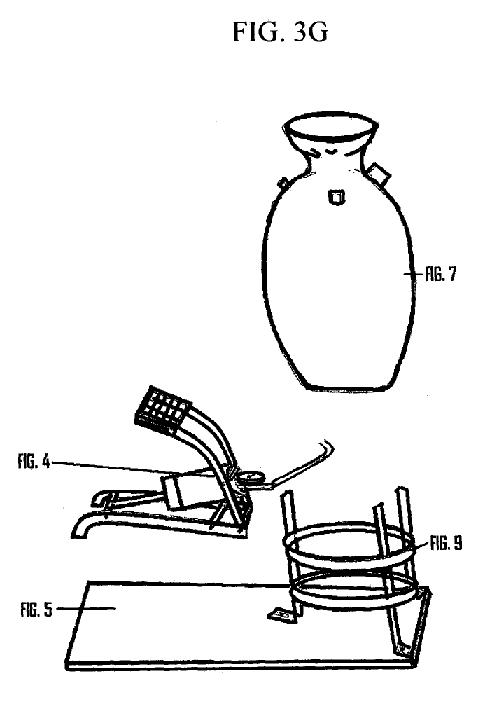

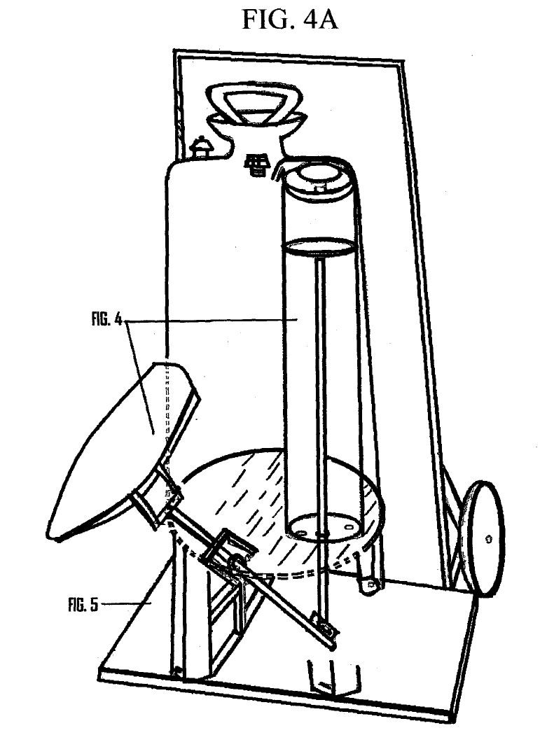

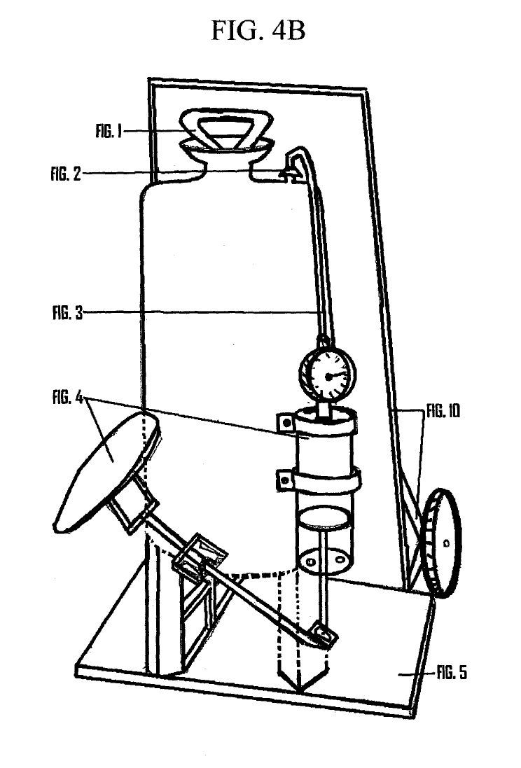

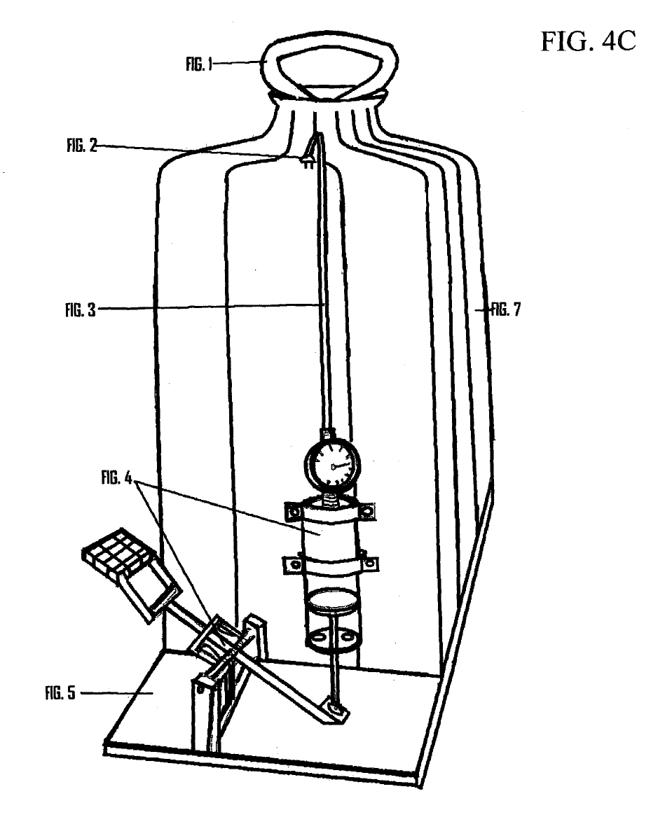

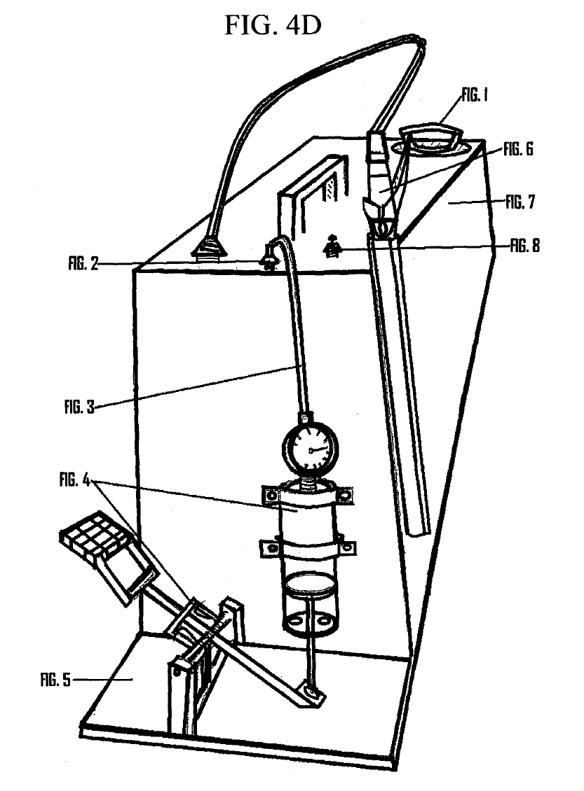

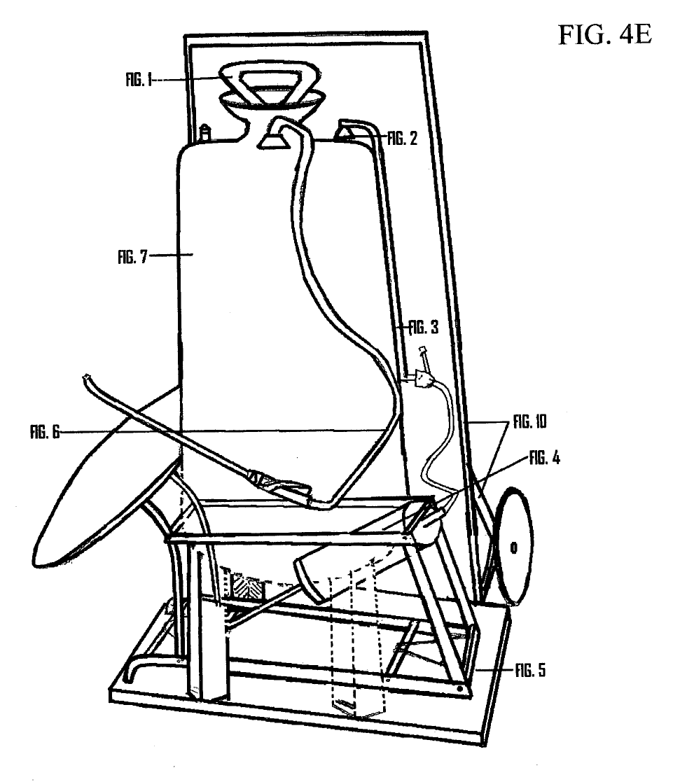

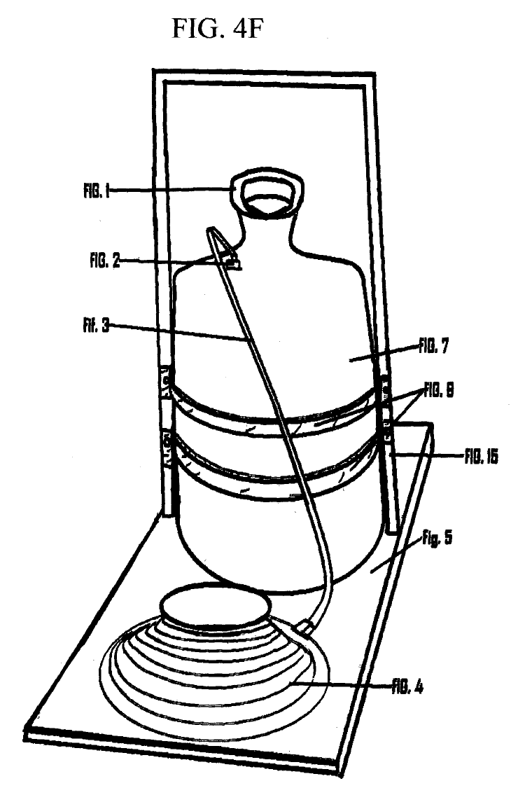

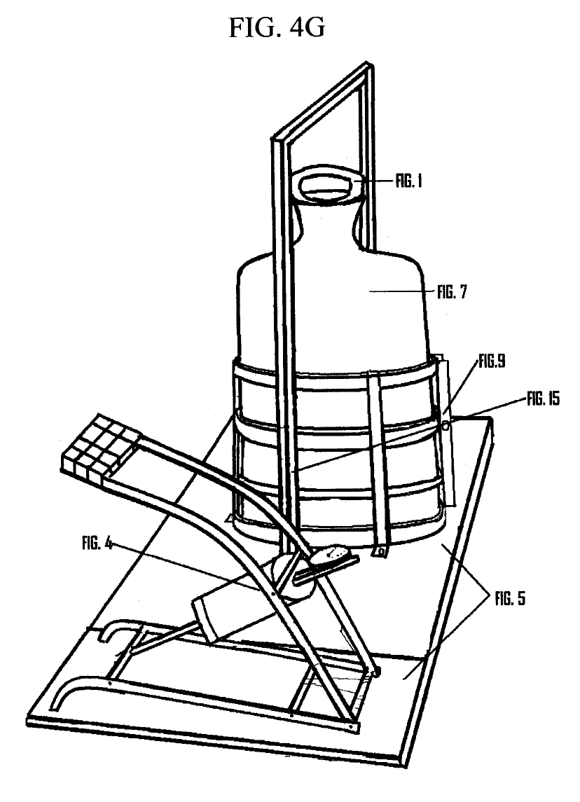

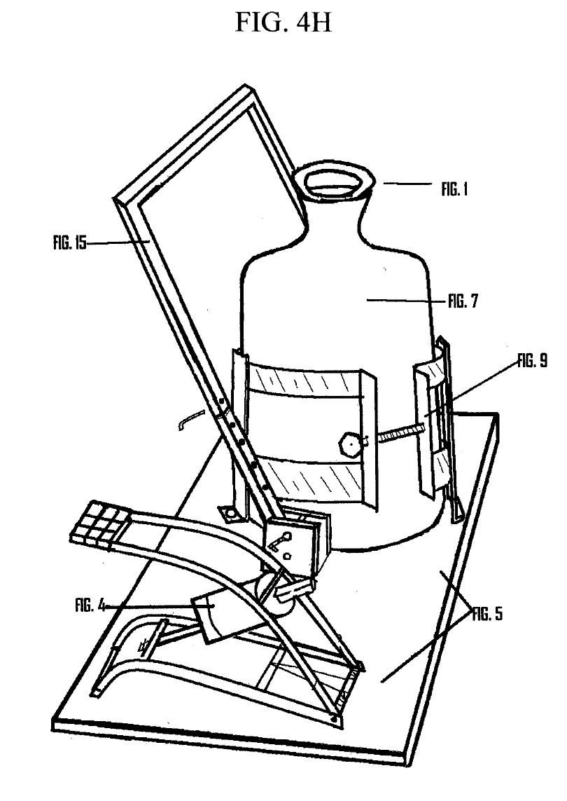

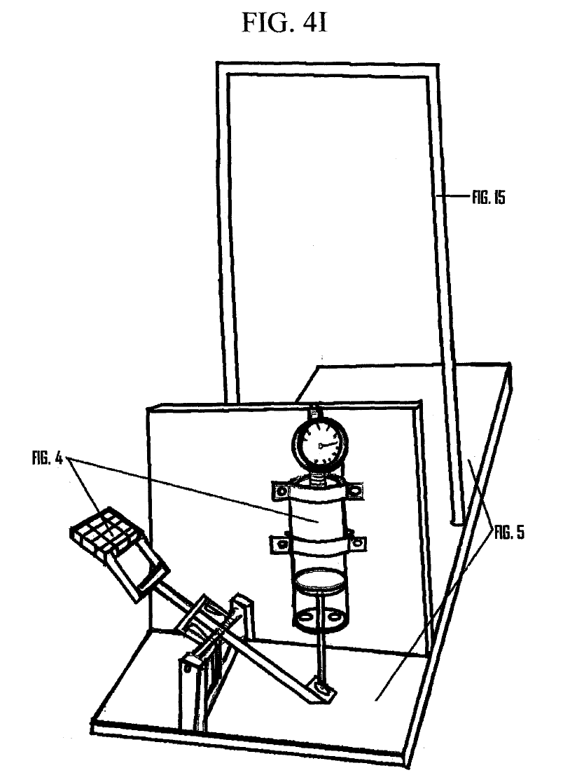

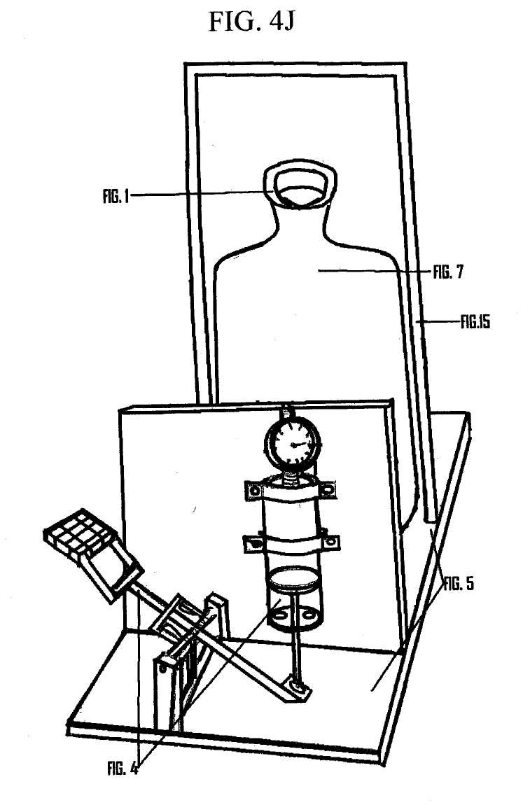

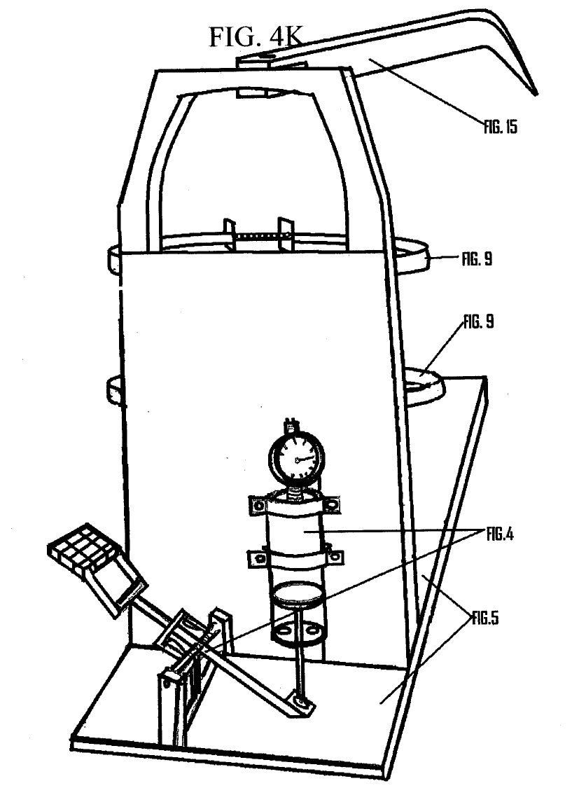

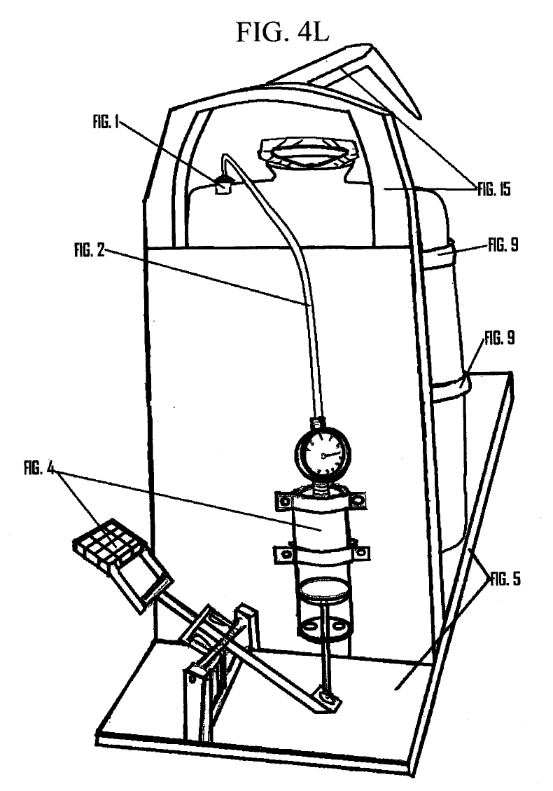

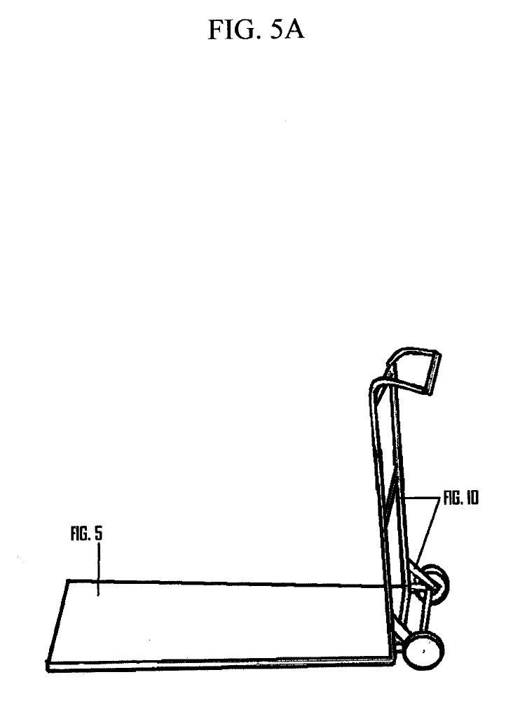

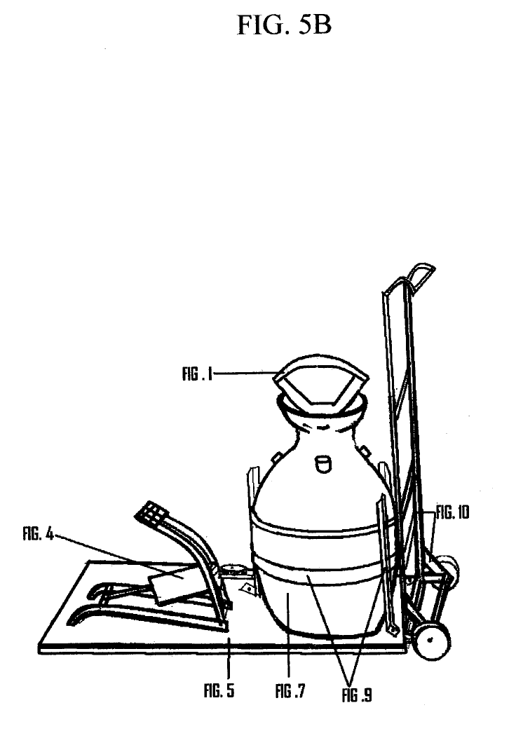

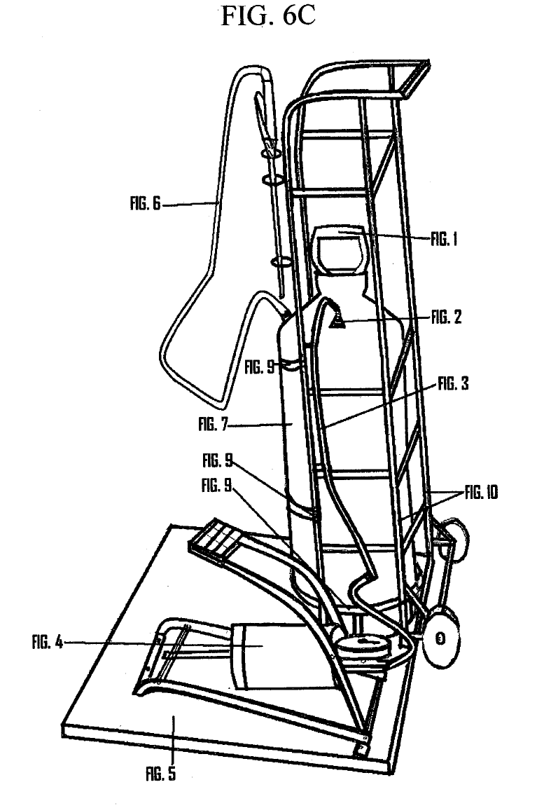

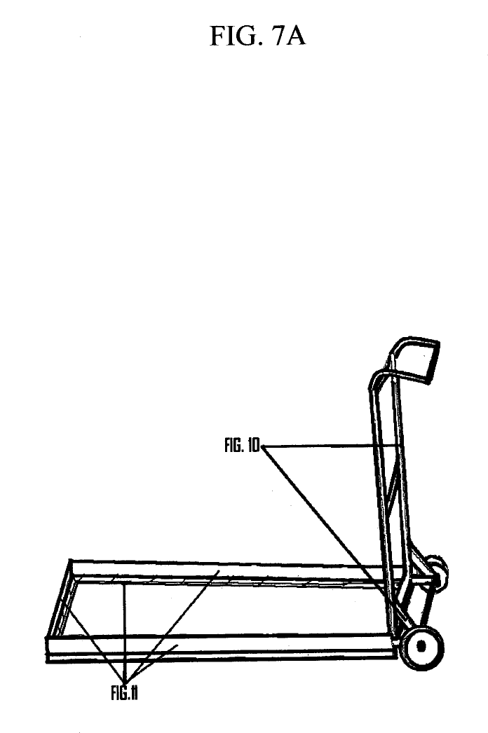

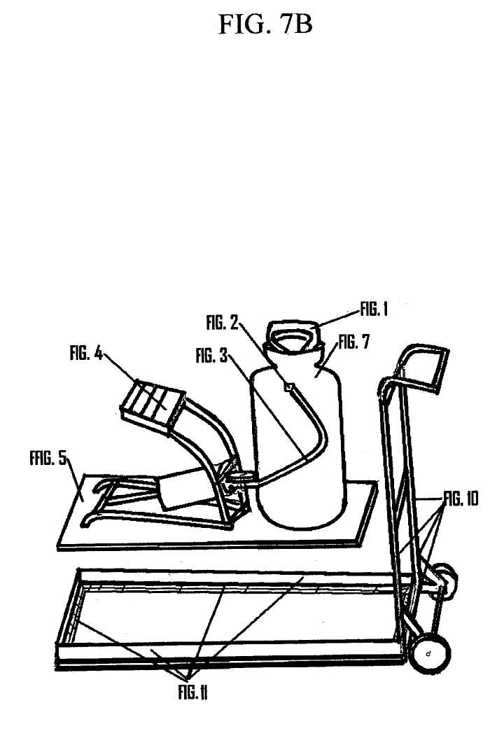

The Easy Sprayer is an assembly of items, a common sprayer and a foot pump brought together so that one the foot pump would make the other the, sprayer easier to use. The core of what makes the Easy Sprayer different from the prior art is its foot operated air pump FIG. 5 used to pressurize the tank FIG. 7 and its base FIG. 4, a platform on witch the foot pump and a sprayer tank are attached. Many models of the prior art, sprayers designed with built in hand operated air pumps to pressurize the sprayer tanks can easily be modified to be an example of an Easy Sprayer. The quickest way to accomplish this is to simply bond the three man components, the base FIG. 4; the foot pump FIG. 5 and the sprayer tank FIG. 7 together. Bonding agents such as those used in the automotive industry, for example metal-to-metal bonders, plastic to metal bonders, plastic-to-plastic bonders, etc. can be used for this purpose FIG. 10. An air inlet FIG. 2 to connect the foot pumps' air hose FIG. 3 to the upper section of the tank must be added. An automotive clamp-in valve stem can be used for this purpose. By providing an air inlet FIG. 2 and bonding a foot pump FIG. 5 and a sprayer tank FIG. 7 to a base FIG. 4 the utility design of the invention (this composition of subject matter) called the Easy Sprayer is effectively copied.

Factory models of the Easy Sprayer can be designed in ways similar to but not restricted to the examples about to be put forward in the following paragraphs. The cap and handle can be solidly made as one-piece FIG. 1, to take the place of the cap designs that incorporate a built in hand operated air pump. An air inlet FIG. 2 to connect the foot pumps' airline FIG. 3 is placed in the upper section of the sprayer tank FIG. 7. It is through this opening that the tank is pressurized; sense the built in hand operated pump design of the prior art has been eliminated. The foot pump FIG. 5 used to supply the air to pressurize the sprayer tank, and the tank FIG. 7 used to hold the liquid that is to be sprayed, can be attached to the base FIG. 4 in a number of ways. Method one glue or bond the foot pump and the tank to the base with bonders such as those used in the automotive industry FIG. 10. Method two the foot operated pump, sprayer tank and the base can be manufactured with boltholes and the assembly bolted together FIG. 11. Method three the foot pump, sprayer tank and the base can be manufactured to snap together FIG. 12. Method four a slide lock design can be used to attach the foot pump and the sprayer tank to the base FIG. 13. Method five a twist lock design can be used to attach the sprayer tank to the base FIG. 14. Different combinations of these assembly methods can be used; for example FIG. 15 shows the foot pump and the sprayer tank in a combination slide and bolt design. FIG. 23 shows a sprayer tank placed between three strips of a sturdy material each strip designed with adjustment at its' base. The sprayer tank is held in place with a strap, belt or band that presses the material against the tank. A foot operated pump can be built directly into a sprayer tank.

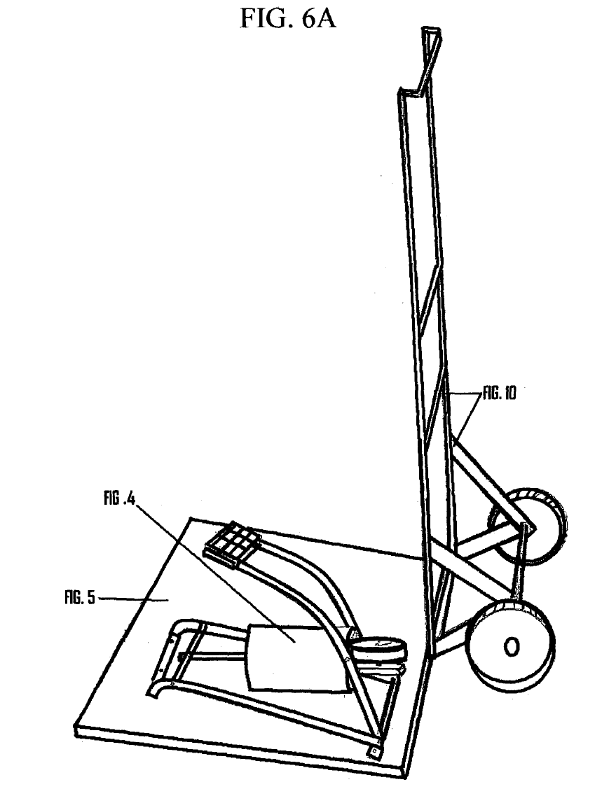

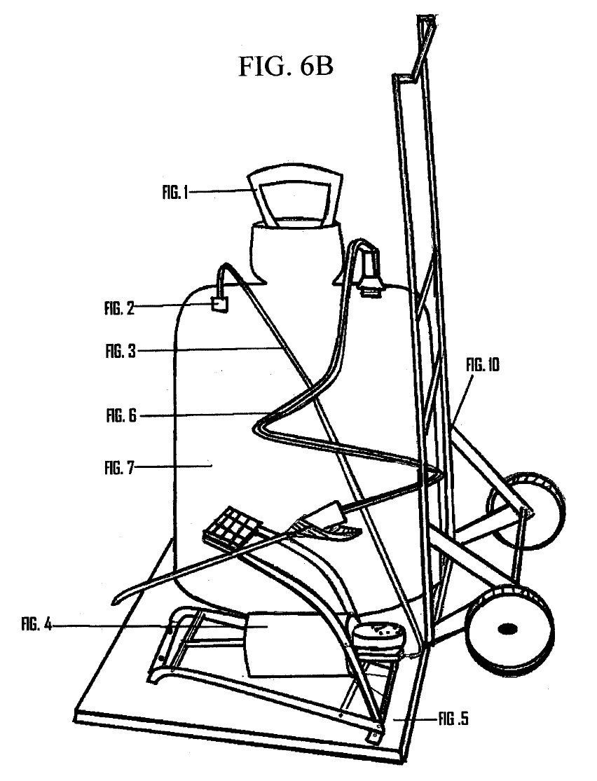

The base in the basic design of the Easy Sprayer can be designed as a lightweight doily, on witch a foot pump and sprayer tank are attached; FIGS. 22, 24, 25, 26, and 27, or a doily can be designed to allow the easy placement and removal of an assembly from it FIGS. 28, 29, 30, 31 and 32. The use of the doily designed as an integrated part of an Easy Spray format was conceived with medium capacity sprayer tanks of three to five gallons, and larger capacity sprayer tanks of six gallons and more in mind to take the drudgery out of carrying the sprayer assembly long distances. Smaller tanks of two gallons or less can also be used in such a composition. The sprayer hose FIG. 6 used in an Easy sprayer composition should be long enough to allow the user to have a wide range of movement.

The items in the Easy Sprayer that are new to the utility design of the sprayer can be assembled as a conversion kit (Example FIG. 16). In such a kit the base is designed so that any sprayer tank within a given capacity range (for example models of sprayers with a capacity of two gallons up to models with a capacity of five gallons); (example models with a capacity of six gallons up to models with a capacity of ten gallons) can be attached to it. The must direct way to accomplish this is to incorporate a clamping mechanism into the base. FIG. 17, and FIG. 23 are each examples of simple restraints. FIG. 17 shows a sheet metal assembly, one section bolted directly to the base, is one and one half feet tall, four inches wide, with a long clamp located near the top that fastens around the second section and a sprayer tank. The second section is held in place by a strip of metal four and one half inches long one inch wide, this allows the section to slide on the base in order to adjust to sprayer tanks of different diameters. It is one and one half feet tall three inches wide; with a long clamp six inches above the base to fasten around the first section and a sprayer tank. The foot pump provided in such a kit can quickly be installed on the base by using methods described for FIGS. 10, 11, 12, 13, 14 and 15. Models of an Easy Sprayer base and foot pump assembly designed with a doily, are perfect for use in either conversion kits or in full factory models of an Easy sprayer. FIG. 22 shows an Easy Sprayer base designed as a doily, foot pump included. Used as part of a kit a sprayer tank can be attached to it by using the means described in FIGS. 17 and 23. FIG. 33 shows an assembly with a basket type retainer as part of the platform that holds a sprayer tank. In this assembly tanks of different capacities are manufactured with the same circumference so that any of several models can fit onto the doily with little need for adjustments of the retainers used to hold the tank in place. This same basic design in the doily can be used to secure the tanks of many different brands of sprayers (when used in conversion kits) as long as they do not far exceed the maximal circumference the side rails of the doily are designed to hold. Different adaptors can be designed to provide a means of attachment of the airline of an air pump to the different models of sprayers. An adapter FIG. (21) that has an air inlet for an airline of an air pump can be attached to the opening on a tank provided for the sprayers' hose. The sprayers' hose can then be attached to the opening on the adaptor provided for it. For sprayers with threaded openings for accessories for things such as pressure release valves etc. adaptors to attach the airline in those locations can be made FIG. (20). . Or solid tops each equipped with an air inlet FIG. 18 can be designed and placed in such a kit to replace the combination hand pump and top assemblies of different models of garden sprayer tanks. A length of sprayer hose FIG. 19 can be included in the kit with hardware; to be used to extend the length of the of the sprayer hose of the sprayer being converted. Different kits can be made brand name and model specific, to account for the different specifications of the openings for the accessories, sprayer hose connections and hand pump and top assemblies of different brands and models of garden sprayers.

To operate the Easy Sprayer remove the cap and fill the tank with a liquid, replace the cap and place the assembly on the ground. Begin pumping the foot-operated air pump sending air through the airline and through the air inlet to pressurize the sprayer tank. The assembly can then be picked up carried and the contents sprayed out until the pressure drops, and then placed back on the ground and pressurized again. A method of operation similar to that of the prior art (sprayers with a built in hand operated air pump design). However the Easy Sprayers' main advantage is that a useable air pressure can be maintained in the tank at all times. In other words the user can pump the foot pump to maintain air pressure in the tank, while at the same time spraying the liquid from the tank. The user can move the Easy Sprayer assembly as needed, a distance while continuing to spray, before placing the assembly back on the ground to resume pumping the pump to rebuild the pressure. The second method of operation described makes it possible to spray the entire contents from the sprayers' tank with out stopping.

The Easy Sprayers' format of a foot operated pump to pressurize a sprayer's tank, its solid cap with handle, its base witch joins foot pump and sprayer tank together, are an improvement in the utility of the common sprayer. Add to these changes in the prior art the use of a doily designed as a integrated part of the assembly of base foot pump and sprayer and you have in total a composition of subject matter that makes the common sprayer physically and technically easier to use.

What I claim as my invention is

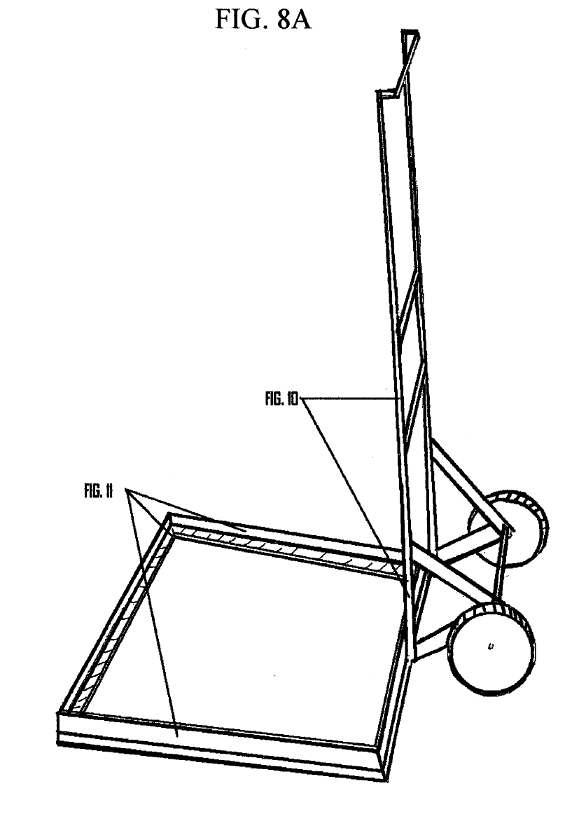

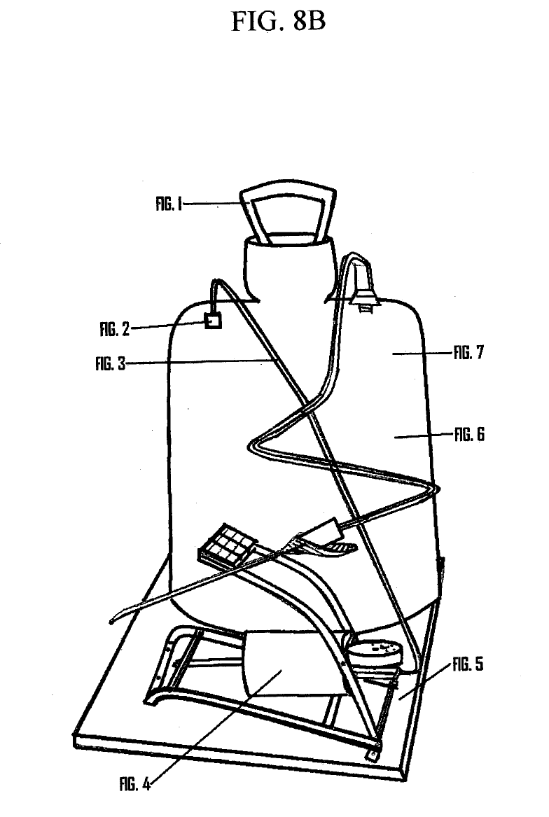

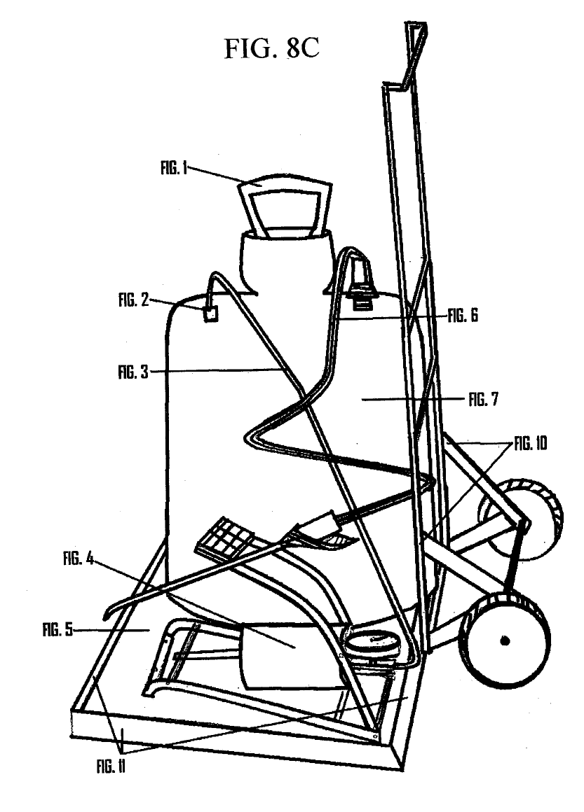

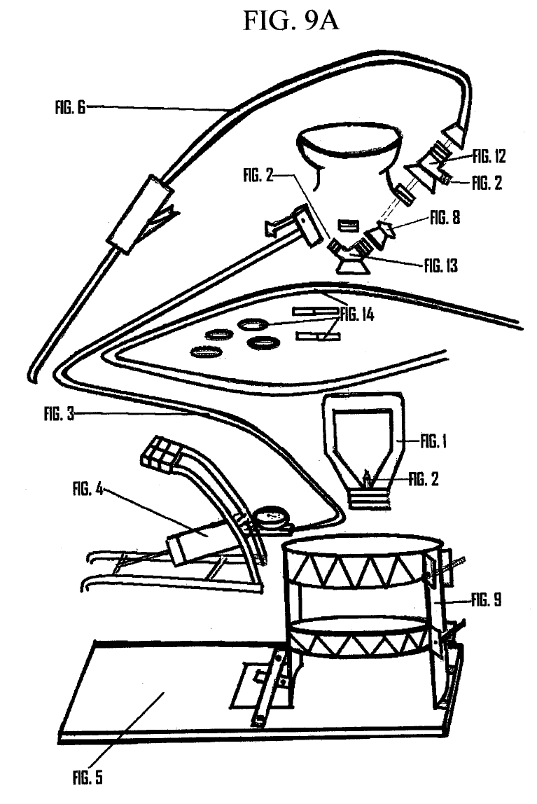

1: A new garden sprayer format, to be a new garden sprayer as put forth in the detailed description, as further pointed out in the claims witch follow and as visualized in the drawings. FIGS. 1 through 33

2: EASY SPRAYER conversion kits as pointed out in claims 10 through 15.

3: The connecting of a foot operated air pump, and a sprayer tank to a common base to form a format that is an improvement in the utility of the prior art of manually operated sprayers.

4: The use of a base as an operating platform for a new format for the common sprayer (garden sprayers, industrial sprayers, etc.) further the use of a doily as part of a base in this format of base (supporting platform), foot-pump (or any pump modified to be operated by the human foot this includes the modification of any hand pump designs in the prior art), and sprayer.

5: The use of any manually operated pumps designed to be operated by a human foot repeatedly pushing down on then releasing the outward moving parts in order to pressurize the tank of a sprayer, this includes any modifications of the hand pumps in the prior art to convert their operation from the use of the hand to the use of the human foot.

6: The addition of an air inlet to the garden sprayer tank to connect the airline of a foot-operated air pump. The use of adaptors designed to allow the connection of the airline of a foot-operated pump to openings such as those for the filler tops, pressure release valves sprayer hoses etc. no different models of sprayer tanks.

7: The use of a cap and handle solidly made as one piece, to seal and carry the sprayer assembly.

8: The different methods of attaching the main components that change the common sprayer into an Easy Sprayer, this includes but is not limited to the methods described in the detailed description, and illustrated in the drawings.

9: a sprayer hose long enough to allow the user of the assembly the fullest range of movement, both when the assembly is being carried and when the assembly is placed on the ground.

10: The use of the subject matter new to the utility design of the sprayer in conversion kits (FIGS. 16 through 23 and FIGS. 24 though 33) to convert the sprayers of different brands and models into versions of an easy sprayer.

11: Conversion kit adaptors with air inlets for the airlines of foot operated air pumps, installed in the locations were the sprayer hose of different models of garden sprayers would normally go, and with openings to install the sprayer hose of the different models of sprayers. FIG. (18)

12: Conversion kit adaptors with an air inlet for the air line of a foot operated air pump installed in the locations were accessories of the prior art such as pressure release valves etc FIG. (19) would go.

13. Conversion kit solid tops with air inlets for the airlines of foot-operated air pumps designed to replace the filler tops and built in hand pumps of different models of garden sprayers FIG. 20.

14: The use of different kinds of clamping devices for example FIG. (17) and FIG. (23) to attach the sprayer tanks of different brands and models of garden sprayers to the base FIG (4) of an Easy Sprayer conversion kit

15: the use of doilies designed with the base and foot pump of an Easy Sprayer assembly as major parts of some Easy Sprayer conversion kits FIGS. 16 through 22.

16: The use of doilies designed as basic parts of the Easy Sprayer assembly. For the smaller models of the Easy Sprayer a doily that can be easily picked up and carried as part of the basic assembly; (FIGS. 22, 24, 25, 26, and 27); for medium size models doilies designed to allow the easy placement of the basic assembly in the doily and the easy removal of the basic assembly from the doily; (FIGS. 28, 29, 30, 31, and 32): for the largest models of the Easy sprayer doilies designed to most securely hold the sprayer tanks (FIG.33).

17: The use of a doily specifically designed to be a part of or specifically designed to transport an assembly that is designed or operates in a manner similar to that of the composition of subject matter described in the pages of this document (The Easy Sprayer: a sprayer assembly in witch a foot operated pump is used to pressurize the sprayer tank).
